(19) United States
(12) Patent Application Publication
(10) Pub. No.: US 2004/0022356 A1
(43) Pub. Date: Feb. 5, 2004

(54) Multi-phenomenology, decision-directed baggage scanning apparatus and method

(76) Inventors: Nikola Subotic, Ann Arbor, MI (US); Christopher Roussi, Kalamazoo, MI (US); Robert A. Shuchman, Ann Arbor, MI (US); Gregory Leonard, Dexter, MI (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/366,084

(22) Filed: Feb. 13, 2003

Related U.S. Application Data
(60) Provisional application No. 60/357,613, filed on Feb. 15, 2002.

(51) Int. Cl. G01N 23/04

(52) U.S. Cl. 378/57

(57) ABSTRACT

A three-dimensional, real-time, multi-phenomenology data reconstruction and fusion system and method are described for scanning bags, luggage, and the like. The approach blends 3D computed topography with other sensing modalities such as magnetic resonance and an embedded decision-directed data reconstruction/exploitation structure to ensure high performance and real-time operation. A 2D array architecture provides sets of 2D projections immediately, which can be exploited as a precursor to a full 3D data reconstruction and exploitation to enhance system speed. Various processing algorithms to determine object type and next best view or reconstructed slice for fast operation at high classification rates; to provide significantly enhanced impulse response performance, such that subtle details are not obscured by bright scattering objects; and to exploit both the multi-modality data and exploited entities for explosive detection, for example.

### REFERENCE TO RELATED APPLICATIONS

This application claims priority from U.S. Provisional Patent Application Serial No. 60/357,613, filed Feb. 15, 2002, the entire content of which is incorporated herein by reference.

### FIELD OF THE INVENTION

This invention relates generally to baggage scanning and, in particular, to a three-dimensional bag-scanning system that uses computed topography with other sensing modalities to ensure high performance and real-time operation.

### BACKGROUND OF THE INVENTION

The terrorist attack of September 11, and subsequent attempts to board aircraft with weapons and explosives have emphasized a significant security vulnerability. Inspection points at airports and federal facilities may currently be breached by anyone with a modicum of understanding regarding existing examination procedures and technologies.

A specific vulnerability is the use of a single-modality, single-projection X-ray machine to image the contents of bags. Current bag inspection technology uses a simple line-scan X-ray device to provide a projective view of a bag and its contents. The movement of the conveyor belt provides the added degree of freedom to construct a 2D image.

An example of a scanned bag is shown in FIG. 1. The bag is typically placed flat down or end-up on the conveyor and is moved through the scanning system. Only one projective view at a single cardinal angle is provided. Because of obscuration, many objects such as boxcutter 120 are obscured. This obscuration can be exploited by a criminal or terrorist to smuggle objects on board of an aircraft.

### SUMMARY OF THE INVENTION

This invention resides three-dimensional, real-time, multi-phenomenology data reconstruction and fusion systems for bag scanning applications. The approach blends 3D computed topography with other sensing modalities such as magnetic resonance and an embedded decision-directed data reconstruction/exploitation structure to ensure high performance and real-time operation.

The concept has the following potential benefits:

1) A 2D array architecture provides sets of 2D projections immediately. These can be exploited as a precursor to a full 3D data reconstruction and exploitation to enhance system speed;

2) Embedded hypothesis testing algorithms may be embedded in the data reconstruction chain to determine object type and next best view or reconstructed slice for fast operation at high classification rates;

3) Fast statistical data reconstruction algorithms provide significantly enhanced impulse response performance, such that subtle details are not obscured by bright scattering objects; and

4) Model-based fusion algorithms can be used to exploit both the multi-modality data and their exploited entities such as quafropole magnetic resonance data for explosive detection. A minimum risk formulation enables the tuning of the algorithms for various performance sensitivities.

### BRIEF DESCRIPTION OF THE DRAWINGS

FIG. 1 shows a traditional projective view of an X-ray scanned bag;

FIG. 2 shows how multiple projections and slices may be used to reveal hidden objects;

FIG. 3 illustrates a decision-directed image formation structure;

FIG. 4 shows how rotating the 2D array in angle provides multiple projective views of the bag;

FIG. 5 shows how back-projection processing only at a specific height reconstructs the applicable slice;

FIG. 6 shows a model-based exploitation approach that uses a Predict, Extract, Match, Search structure;

FIG. 7 shows a fusion structure which incorporates multiple looks or multiple sensor modalities; and

FIG. 8 shows the attenuation signature of various materials are distinct.

### DETAILED DESCRIPTION OF THE INVENTION

Three-dimensional (3D) computed tomography (CT) has been in practice for a number of years in the biomedical imaging community. These data sets have been used to provide a 3D spatial context of the placement and orientation of organs in the body. In addition, this placement reveals otherwise obscured aspects of the body such as lesions and injuries which would ordinarily be obscured by other organs. According to this invention, similar technology is applied to the bag inspection area with some of the same benefits; namely, true 3D placement and orientation of the objects contained in a bag; and the mitigation of obstruction of one object by another.

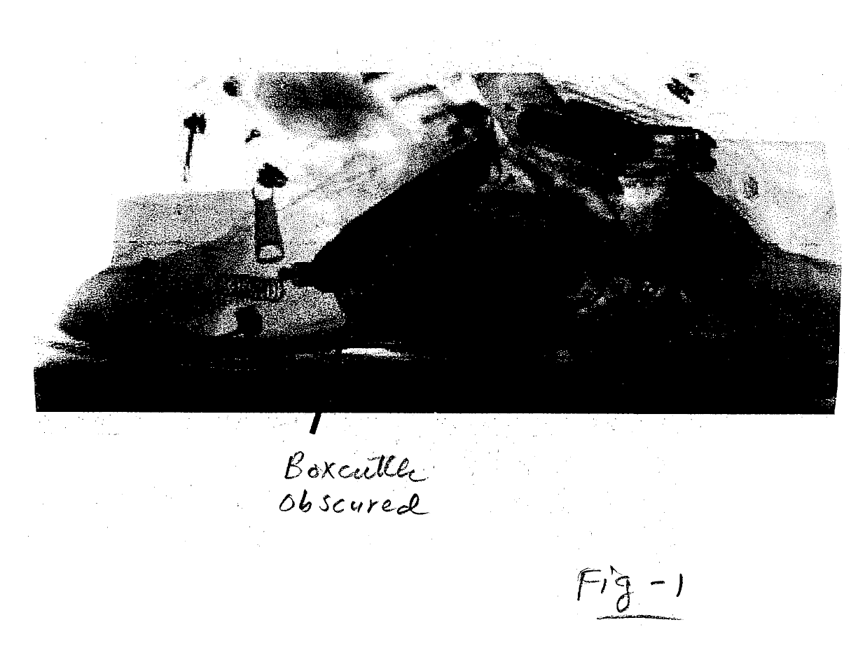

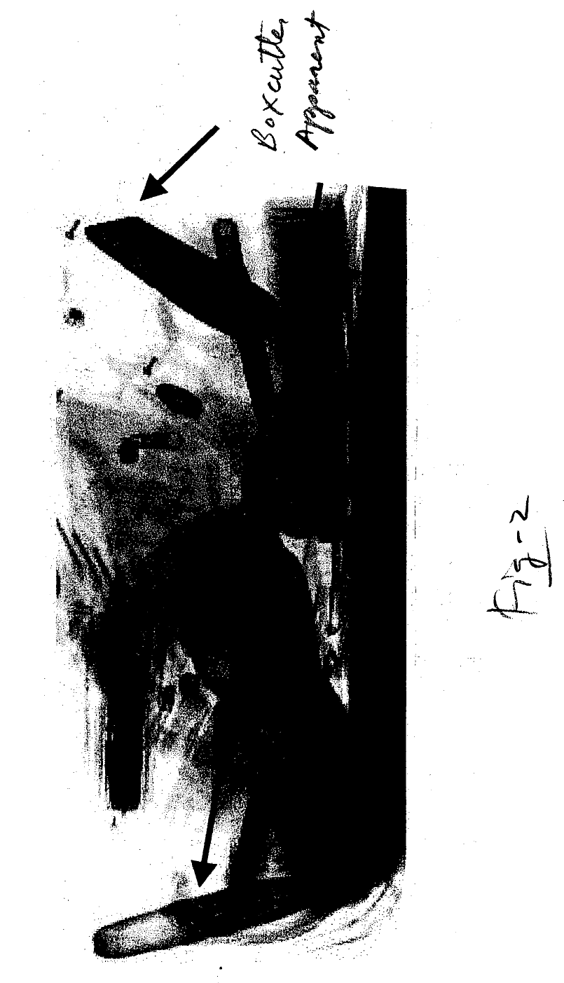

Exploiting the full 3D data set provides the ability to choose or fuse a multiplicity of angular views of the bag revealing heretofore obscured objects. In addition, slices of the data can be constructed and exploited that gives a fundamentally different view (non-projective) of the bag. FIG. 2 shows a set of projections and slices of the same bag as in FIG. 1. Note that many objects, specifically box cutters and weapons are now clearly visible which were not in the classis single projective view.

Commercial CT systems are typically of very high power and size. This is due to the use of fan beam illumination, line arrays and helical scans to build up the 3D data set. Using linear arrays causes most of the emitted X-rays to impinge on lead and are wasted. In the preferred embodiments of this invention, planar arrays are used instead of the linear detectors to significantly enhance system efficiency. This enables the system to be built in a smaller package.

Decision Directed Image Reconstruction

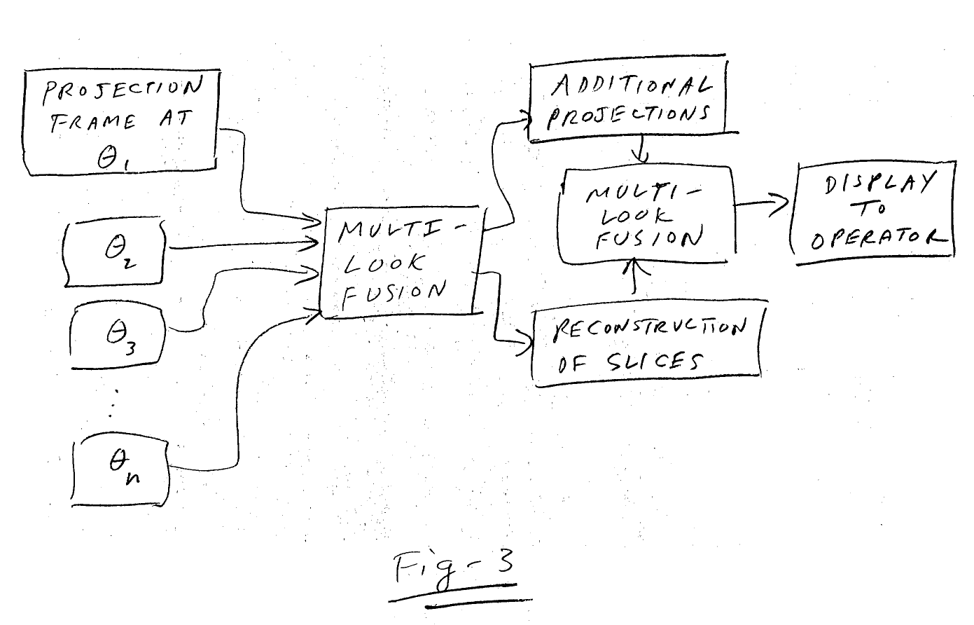

One of the major technical issues to be overcome in the development of this technology is the real-time requirement of operation for such a system. Long latency times cannot be tolerated. Consequently, classic batch mode processing, whereby the entire data set is collected, reconstructed and then exploitation commences is not a viable approach. We therefore propose an embedded scheme, where hypothesis testing based data exploitation is embedded into the data reconstruction system. According to this invention, decisions are made adaptively and dynamically regarding the object type, what is the next best view, which slices must be reconstructed next and how/how much data must be fused to provide a high confidence detection of a prospective weapon or explosive. This architecture is shown in FIG. 3. We term this architecture ‘decision directed image reconstruction.’

Examining FIG. 3, a set of images are taken directly from the data at, say, 4 cardinal angles. These images are readily provided by the 2D detector array. These various looks at the same object are then fused to perform object recognition. The object recognition algorithm according to the invention may have multiple declarations. For example, it can declare that a specific object of interest is present, it can declare that no object of interest is present and it can declare that it does not have enough evidence to make any hard decision. Based on the algorithm declaration, additional projections can be collected or a specific slice of the bag can be reconstructed. The new data is now incorporated with the old within our fusion structure until a declaration is made. The algorithm will be set such that if there is an indeterminate declaration at the end of the data collection cycle, the bag must be opened for inspection.

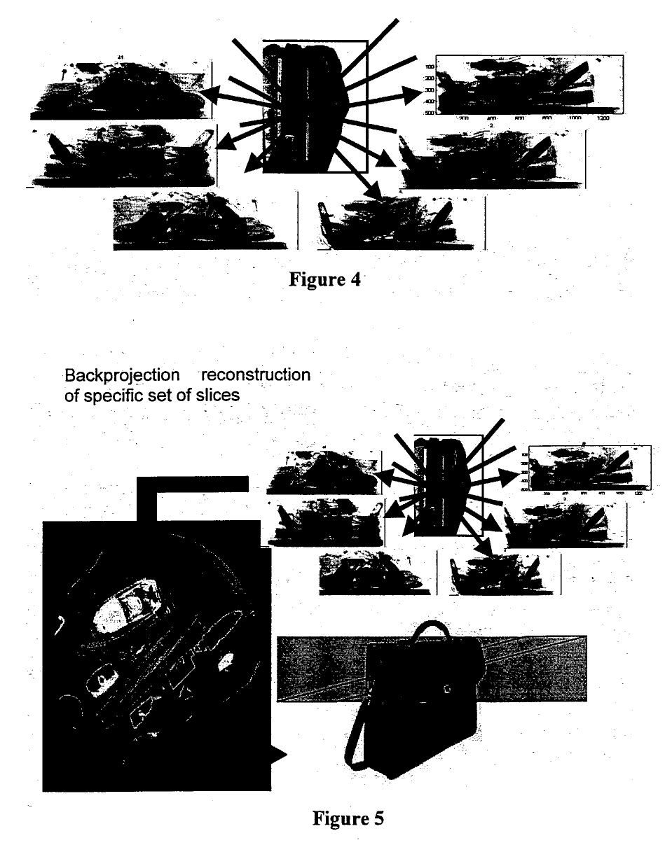

Two types of data available in this 3D sensor modality: 1) projection data; and 2) slice data. A set of projections are shown in FIG. 4. The slices require reconstruction from the various projections. FIG. 5 shows the construction of a slice from a set of projections of a bag. Slices provide a distinctive view of the contents which can easily identify objects of interest. Slices through the object must be reconstructed via the angular projections of the data. In classic batch mode processing, all slices throughout the object are reconstructed. This is computationally very intensive. In our decision-directed approach, the analysis of the projection isolates which slices need to be reconstructed. Only those slices will be reconstructed, thereby making the data exploitation/object recognition operation much more efficient.

Multi-Modality Fusion for Imaging and Material Identification

Our approach is based on statistical hypothesis testing formulations. We incorporate a minimum risk formulation based on models of the objects of interest. This is written as

$${min}_{{H}_{k}} R ( {H}_{k} \vert \overline{x} ) = {\sum }_{j = 1}^{J} {C}_{kj} P ( {H}_{j} \vert \overline{x} ) = {\sum }_{j = 1}^{J} {C}_{kj} P ( {H}_{j} ) P ( \overline{x} \vert {H}_{j} )$$

where Cₖⱼ are the costs of making declarations, P(Hⱼ) is the prior probability of hypothesis (object) Hⱼ and P(x|Hⱼ) is the likelihood of the data under hypothesis Hⱼ. The Bayesian nature of the approach also allows for the selective sensitization of the algorithm based on off-line intelligence, etc. to optimize performance.

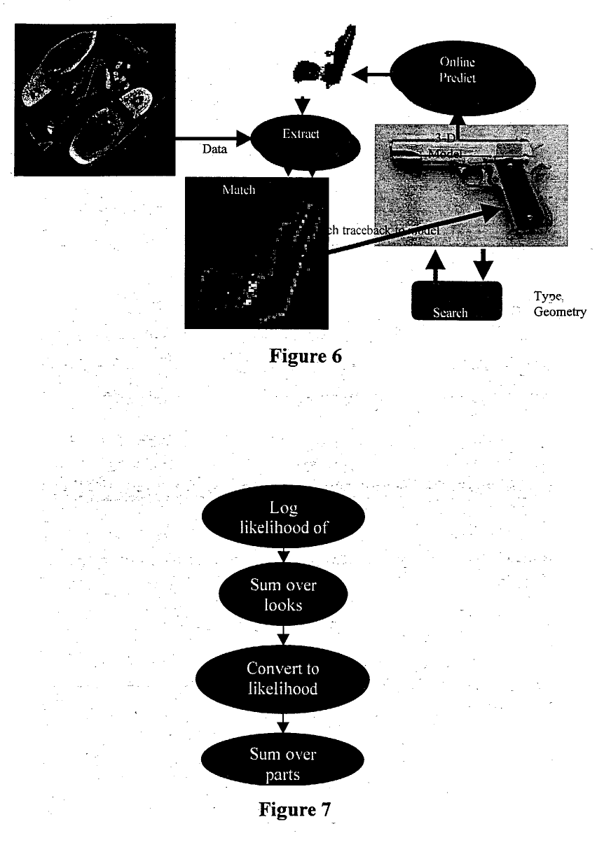

Our implementation of the minimum risk classifier is done via a Predict, Extract, Match, and Search (PEMS) loop. In effect, the algorithm plays a sophisticated form of the game “20-questions.” Using generic models for objects of interest, their extracted signatures (e.g. edge boundaries) can be predicted and matched to that of the collected data. The search routine analyzes the specific mis-match that is found between the collected data and that predicted which engenders another query. This loop is repeated until an acceptable match score is found or a processing time requirement is met. This type of structure has been used extensively in DARPA funded automatic target recognition programs for synthetic aperture radar. Examples of this are the Moving and Stationary Target Algorithm Research (MSTAR) and Dynamic Database (DDB) programs, incorporated by reference in their entireties. A PEMS loop is illustrates in FIG. 6.

A generalized likelihood ratio test (GLRT) is constructed in accordance with conjectured objects, their sizes and orientations. For 3D X-ray based sensors, the problem can be reduced to a Bernoulli trial formulation on the object boundary edges as:

$$P ( x \vert {C}_{jl}^{′} {H}_{j} ) = {\prod }_{k = 1}^{K} {\prod }_{{x}_{ik} ∈ {C}_{jkl}^{′}}^{} {{p}_{ijkl}^{{x}_{ik}} ( 1 - {p}_{ijkl} )}^{( 1 - {x}_{ik} )}$$

Where Pᵢⱼₖₗ is the probability of the presence of an edge for a specific object and orientation. Using this formulation, the system can be distributed in the reconstruction chain and use both raw data and exploited entities within its hypothesis testing and fusion structure. The fusion structure has a very simple implementation as shown in FIG. 7.

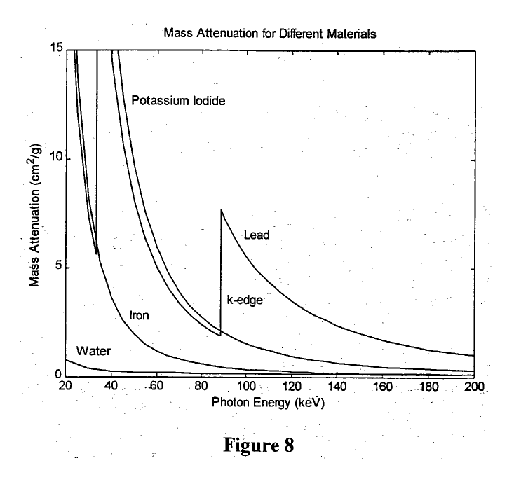

Multi-energy fusion of CT data can provide additional information above that of just the 3D spatial absorption coefficient. More precisely, the changes in absorption spectra provide information as to the type of material is contained in an object. FIG. 8 shows the absorption signatures of water and potassium, showing the k-edge absorption areas and the absorption fall-off above those edges.

We claim:

1. A method of scanning a piece of luggage or other article to identify contents therein, comprising the steps of:
storing information regarding one or more objects of interest;
generating an initial projection of the contents using penetrating radiation along one orientation through the bag;
comparing the initial projection to the stored information; and
providing one of the following outputs:
a) that the object of interest is present among the contents,
b) that no object of interest is present, or
c) that there is insufficient evidence to formulate a definite decision regarding a) or b).

2. The method of claim 1, including the step of performing an additional operation based upon the result of the comparison.

3. The method of claim 2, wherein the additional operation is a more complete reconstruction of data associated with the initial projection.

4. The method of claim 2, wherein the additional operation includes generating one or more subsequent projections along different orientations through the bag.

5. The method of claim 4, wherein the additional operation includes determining the next best orientation to generate a subsequent projection.

6. The method of claim 4, wherein the additional operation includes determining how additional projections should be generated to analyze and compare the initial or subsequent projections to the stored information.

7. The method of claim 2, wherein the additional operation includes constructing a three-dimensional representation of the contents in accordance with the initial and subsequent projections.

8. The method of claim 2, wherein the additional operation involves generating a signal that the bag must be opened for further inspection.

9. The method of claim 1, wherein the objects of interest are weapons.

10. The method of claim 1, wherein the stored information includes generic models of the objects of interest.

11. The method of claim 1, wherein the stored information includes edge boundaries of the objects of interest.

12. The method of claim 1, further including the step of sensing information in addition to the projections.

13. The method of claim 12, including the detection of absorption spectra representative of a material contained in the object.

14. The method of claim 13, wherein the absorption spectra are associated with potassium.

15. The method of claim 14, wherein the absorption spectra shows k-edge absorption areas and the absorption fall-off above those edges.

16. The method of claim 14, wherein the penetrating radiation is in the form of x-rays.

17. Apparatus for scanning a bag to identify its contents, comprising:
an imager operative to generate an initial projection of the contents of the bag along one orientation through the bag;
a memory for storing information regarding an object of interest; and
a processor operative to analyze and compare the initial projection to the stored information and provide one of the following outputs:
a) that the object of interest is present among the contents,
b) that no object of interest is present, or
c) that there is insufficient evidence to formulate a definite decision regarding a) orb).

18. The apparatus of claim 17, wherein the processor is operative to perform an additional operation based upon the result of the comparison.

19. The apparatus of claim 18, wherein the additional operation is a more complete reconstruction of data associated with the initial projection.

20. The apparatus of claim 18, wherein the additional operation is to direct the scanner to generate one or more subsequent projections along different orientations through the bag.

21. The apparatus of claim 18, wherein the additional operation includes a determination of the next best orientation to generate a subsequent projection.

22. The apparatus of claim 18, wherein the additional operation includes a determination of how additional projections should be generated to analyze and compare the initial or subsequent projections to the stored information.

23. The apparatus of claim 18, wherein the additional operation is to construct a three-dimensional representation of the contents in accordance with the initial and subsequent projections.

24. The apparatus of claim 18, wherein the additional operation is a signal that the bag must be opened for further inspection.

25. The apparatus of claim 17, wherein the objects of interest are weapons.

26. The apparatus of claim 17, wherein the imager includes a two-dimensional image detector.

27. The apparatus of claim 17, wherein the stored information includes generic models of the objects of interest.

28. The apparatus of claim 17, wherein the stored information includes edge boundaries of the objects of interest.

29. The apparatus of claim 17, further including one or more sensors to provide information in addition to the projections.

30. The apparatus of claim 17, including a sensor to detect changes in absorption spectra representative of the type of material is contained in an object.

31. The apparatus of claim 17, including a sensor to detect absorption spectra representative of a material contained in the object.

32. The apparatus of claim 17, wherein the absorption spectra is associated with potassium.

33. The apparatus of claim 17, wherein the absorption spectra shows k-edge absorption areas and the absorption fall-off above those edges.
